(19) United States
(12) Patent Application Publication
(10) Pub. No.: US 2006/0016394 A1
(43) Pub. Date: Jan. 26, 2006

(54) Device for a colour change during application of a uniformly thin liquid film over the working width of a material web

(75) Inventor: Manfred Aulbach, Momlingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: Fleissner GmbH

(21) Appl. No.: 11/142,001

(22) Filed: Jun. 1, 2005

(30) Foreign Application Priority Data
Jul. 22, 2004 (DE) 102004035624.6

(51) Int. Cl. B05C 11/00

(52) U.S. Cl. 118/688

(57) ABSTRACT

For a colour change in a pour-on system two application devices are provided one behind the other which are not jointly active at the same time for the dyeing. One of the two devices is brought to a standstill for the production by stopping the pumping of dye liquid for the dyeing and is cleaned and supplied with new dye liquid during the rest period. Not only stopping the pump but a liquid deflecting rail which deflects the liquid which is still flowing off into a collecting tray is used for exactly separating the film at the device which is active so far. This brings about a sharp-edged end of the application so far and a sharp-edged start of the new application.

The invention relates to a device for applying a liquid film, which is uniformly thin over the working width and flows laminarly over a continuously advanced material web, preferably having a large working width, and controlling this device by means of a liquid conveyed by a time-activatable pump, comprising a liquid distribution device and a liquid distribution compartment provided thereon and connected to said pump via an inflow pipe and comprising an associated guiding surface adjacent to the liquid distribution compartment and aligned at an angle to the horizontal, from whose lower edge the outflowing liquid film flows onto the material web.

A device of this type is known, for example, from EP-A-0 472 050 or WO 2004/048671. The design of this device ensures that the dye liquor is applied uniformly in each desired quantity over the working width of the material web. A solution is to be sought as to how a fast change of dye liquor can be achieved with this device whilst the material web advances uniformly unchanged without too much of the length of the material web being lost as unclean or undyed.

It is known to provide two application units for this purpose of which only one at a time actually dyes. For this purpose two liquid distribution units are associated with the guiding surface of an application device which can be swivelled into the working position as required whilst the material web advances unchanged. This solution comprises a large amount of mechanics in the swivelling device and does not provide satisfactory speed of colour change with a clean sharp-edged colour transition.

It is also known to provide two application devices fixed in position, one after the other and directed towards one another but this is to pour two different dye liquids onto the material web at the same time.

It is the object of the invention to find a device which can be used to make a quick colour change without pivotable application units.

Starting from the device of the type specified initially, the solution found for the formulated object consists therein that for one advanced material web, two of these application devices, each having a pump, are arranged in the same alignment at a distance one behind the other and are associated with the material web, furthermore, only one of these devices at a time is supplied with the liquid for application as prescribed via the associated pump, wherein the pumps of the two devices are controlled for conveying the respective liquid for application such that the actual section between the application devices is optimised with regard to the time-activated application activity, in the sense of a shortened empty section of the material web.

The idea is simple in design but very advantageous in effect. During the colour change the conveying pump of the first application device is stopped and the following or the preceding pump is activated and in such a specific manner that no double dyeing or no undyed areas are obtained on the material web. This control of the two application devices or their pumps can easily be achieved depending on the speed of the material web.

In order to further speed up the colour change and also to exactly determine the end of the liquid running over the guiding surface, it is advantageously further provided that in both application devices a liquid collecting tray provided with a drain is arranged below the same and above the material web, wherein the respective liquid collecting tray is arranged in a fixed position and its wall associated with the lower edge of the guiding surface of the application device has its lower edge displaced backwards with respect to the plane of the off-flowing liquid film. In addition, a liquid deflecting rail extending over the working width of the application device is arranged so that it can be moved forwards and backwards in the area below the edge of the guiding surface. With this liquid deflecting rail and the associated collecting tray the end or the beginning of the application can be determined absolutely exactly within seconds. The liquid running off into the collecting tray can be reused or removed into the dirty water channel during the rinsing process by means of corresponding valves. The colour change can be optimised to a few centimetres of the length of the material web exactly over the width of the material web.

A device of the type according to the invention is shown as an example in the drawings. In the figures:

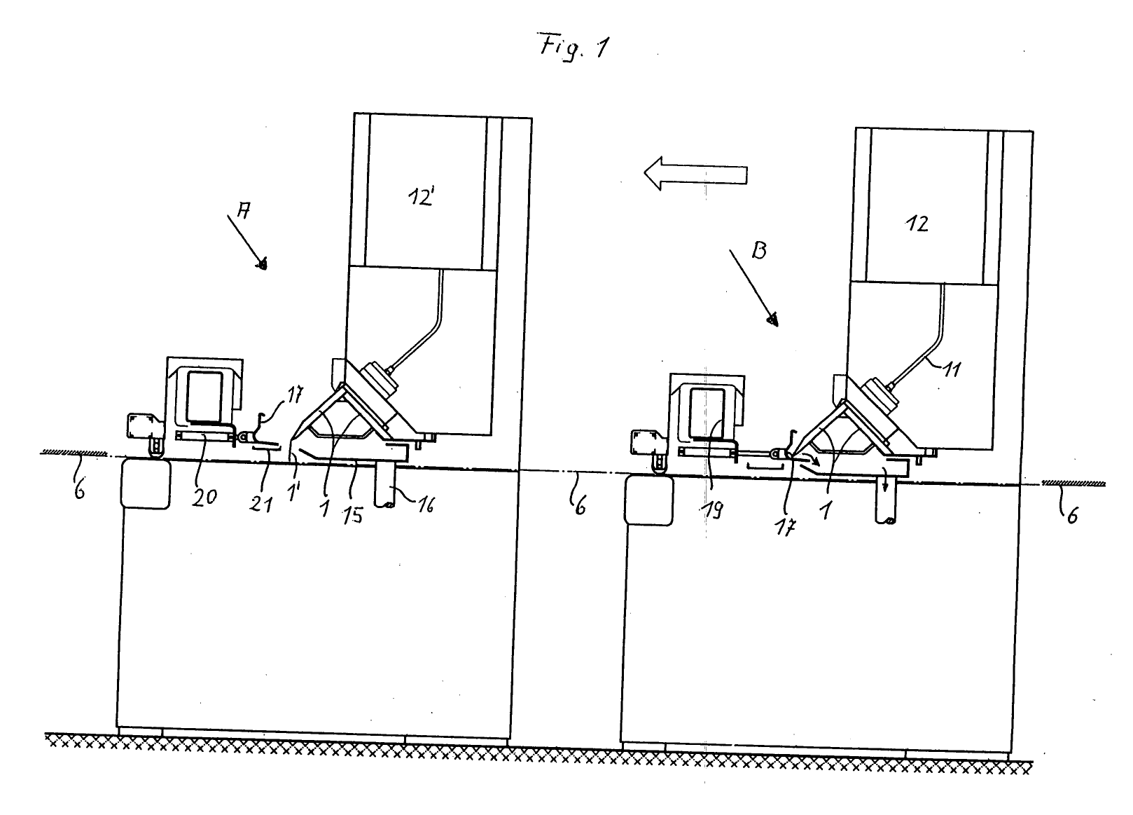

FIG. 1 is a side view of two application devices one behind the other, which run through a material web one behind the other and

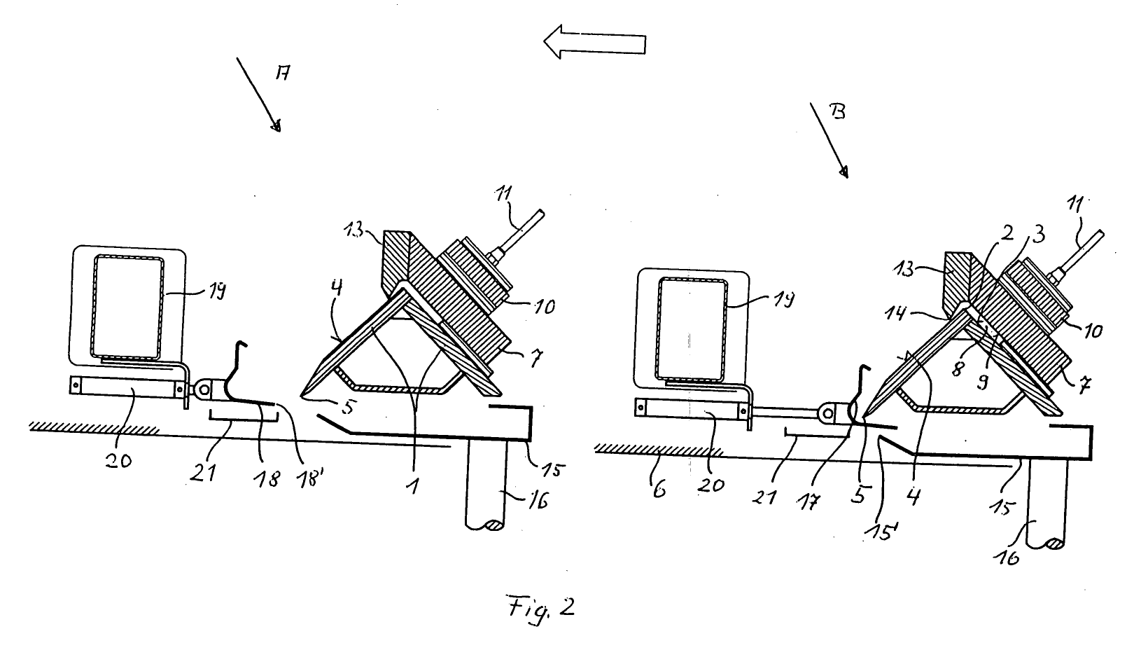

FIG. 2 is an enlarged cross-sectional view of the application beam only.

The two liquid application devices A and B having the same structure according to FIG. 1 each consist of an angular beam 1 whose 90°-embracing overflow weir 2 is aligned upwards. The leg running obliquely upwards with respect to the overflow weir is the retaining wall 3 adjacent to which after the overflow weir 2 is the guiding surface 4. The liquid film or layer to be applied flows uniformly distributed over this guiding surface, flowing onto the material web 6 after running off from the lower edge 5 of the guiding surface 4.

Affixed in a liquid-tight fashion on the side opposite to the retaining wall 3 of the beam 1 is a solid member 7, the liquid distribution member, which has a liquid supply compartment 8 in the area associated with the overflow weir 2. According to FIG. 1, this liquid supply compartment 8 is initially bounded by the retaining wall 3 and the counter-retaining wall 9 of the liquid distribution member which is arranged thereabove at a distance and runs parallel thereto.

The design of the retaining and liquid distribution unit can also be differently constructed and be within the scope of the invention, the only important thing being the need for the liquid to be poured on to run over the guiding surface 4 and flow onto the material web 6 from the edge 5.

The liquid intake area is located at the end of the liquid supply compartment 8 opposite to the overflow weir 2. This consists of a plurality of holes extending transversely through the liquid distribution member 7 which then have liquid inflow openings at the lower end of the liquid supply compartment 9. Located at the opposite upper end of the holes is a liquid distribution device 10 such as that described in EP-A-0 472 050. The liquid for application reaches said device uniformly over the working width via the pipes 11 from the previously arranged distribution system, which is merely indicated, via a conveying pump, which is not shown.

Normally it is sufficient if the inflowing liquid stream flows off to the overflow weir 2 and from there over the guiding surface 4. Only when the applied quantities are large, 50 l/m/min or more, is there a risk that the liquid distributed over the working width of the application device has such a high inflow velocity that the kinematics exceeds the gravity at the overflow weir 2. With these large applied quantities, it can happen that the liquid regularly shoots away over the overflow weir 2. In order to avoid this, according to WO 2004/048671 a liquid deflecting block 13 which forces the inflowing liquid is attached in the area of the overflow weir over the length of the application device. This has a lower edge 14 which forms a defining flow gap with the guiding surface 4.

According to FIGS. 1 and 2, two of these pouring-on application devices A and B are arranged one after the other in the direction of advance of the material web 6 and at a short distance from one another. In principle, only one device is always operating and the second, whether A or B, after cleaning remains ready for operation in the waiting position until the colour change is notified. In the case shown in FIGS. 1 and 2 the pump 12 stops the device B currently active and the pump 12′ starts the device A after a certain time interval, namely until the material web 6 with the undyed area has arrived underneath the device A. The liquid film 1′ then flows. This colour change can take place abruptly with no distance or only a small distance between the two dyed surfaces on the material web 6.

In order to ensure an abrupt change of colour, underneath the beam-shaped application head 1 with the guiding surface 4 and above the material web 6 there is provided a liquid collecting tray 15 with a drainage channel 16 located at the side outside the width of the material web, into which the dye solution used so far is diverted. The edge 15′ of the liquid collecting tray 15 associated with the run-off edge 5 ends before the plane 1′ of the liquid film running off from the guiding surface 4 in order to ensure unhindered application there. The material web 6 is secured from undesired application by means of a liquid deflecting rail 17 extending over the entire working width which surrounds the run-off edge 5 of the guiding surface 4 in its cross-section according to device B. The lower wall 18 of the liquid deflecting rail 17, when this is functioning, i.e., in the advanced state according to B, extends with its run-off edge 18′ above the collecting tray 15 so that the residual dye liquid still running off finally over the guiding surface 4 is collected and can be transported into the tray 15 as shown by the arrow. The liquid deflecting rail 17 is affixed to a support 19 extending over the working width of the application device and can be displaced forwards and backwards by means of a pneumatically actuated cylinder 20.

When the rail 17 is withdrawn as shown in device A, a collecting rail 21 is arranged fixedly along the deflecting rail 17 underneath the liquid deflecting rail 17 so that any undesired residual solution dripping from the run-off edge 18′ onto the device can be collected without damaging the material web 6. A collecting rail can also be affixed underneath the lower wall 18 of the liquid deflecting rail 17 and moved to and fro therewith.

The two application devices A and B are controlled by means of electrical impulses for the pumps of the two application devices and the movement device such as pneumatic cylinders of the liquid deflecting rails in a coordinated manner taking into account the speed of advance of the material web such that the area of the material web not wetted by one of the different application liquids is only a few centimetres. During the prescribed activity of the one application device (A), the adjacent application device has its application activity temporally stopped by the advanced liquid deflecting rail 17 (B). Said device can be prepared for a future application activity by rinsing and removing the rinsing liquid by means of the advanced liquid deflecting rail and the associated liquid collecting tray and is supplied in good time and completely with the following liquid for application.

1. A device for applying a liquid film, which is uniformly thin over the working width and flows laminarly over a continuously advanced material web, preferably having a large working width, and controlling this device by means of a liquid conveyed by a time-activatable pump, comprising a liquid distribution device (12) and a liquid distribution compartment (8) provided thereon and connected to said pump via an inflow pipe (11) and comprising an associated guiding surface (4) adjacent to the liquid distribution compartment (8) and aligned at an angle to the horizontal, from whose lower edge (5) the off-flowing liquid film flows onto the material web (6), characterised in that for one advanced material web (6) two of these application devices (A, B) each having a pump are arranged in the same alignment at a distance one behind the other and are associated with the material web (6), furthermore only one of these devices (A) at a time is supplied with the liquid for application as prescribed via the associated pump, wherein the pumps of the two devices are controlled for conveying the respective liquid for application such that the actual section between the application devices (A, B) is optimised with regard to the time-activated application activity in the sense of a shortened empty section of the material web.

2. The device according to claim 1, characterised in that in both application devices (A, B) a liquid collecting tray (15) provided with a drain is arranged below the same and above the material web (6).

3. The device according to claim 2, characterised in that the respective liquid collecting tray (15) is arranged in a fixed position and its wall associated with the lower edge (5) of the guiding surface(4) of the application device has its lower edge (15) displaced backwards with respect to the plane of the off-flowing liquid film (1′).

4. The device according to claim 3, characterised in that a liquid deflecting rail (17) extending over the working width of the application device (A, B) is arranged so that it can be moved forwards and backwards in the area below the edge (5) of the guiding surface (4).

5. The device according to claim 4, characterised in that the liquid deflecting rail (17) is affixed on a support (19) extending over the working width of the application device (A, B) above the advancing material web (6) so that it can be displaced forwards and backwards.

6. The device according to any one of claims 4-5, characterised in that the liquid deflecting rail (17) has a lower wall (18) with a run-off edge (18′) which is arranged above the liquid collecting tray (15) when the rail (B) is advanced.

7. The device according to any one of the preceding claims, characterised in that a drip catching device (21) is associated with the run-off edge (18′) of the liquid deflecting rail (17) underneath the same.

8. The device according to claim 7, characterised in that the drip catching device is embodied as a stationary collecting rail (21) over the length of the run-off edge (18′) in the withdrawn rest position of the liquid deflecting rail (17).

9. The device according to any one of the preceding claims, characterised in that the two collecting devices (A, B) are arranged horizontally one behind the other.

10. Control of the two application devices according to any one of claims 1-9, characterised in that the pumps of the two application devices are controlled by means of electrical impulses and the movement device such as pneumatic cylinders of the liquid deflecting rails in a coordinated manner taking into account the speed of advance of the material web such that the area of the material web not wetted by one of the different application liquids is only a few centimetres.

11. Control of the two application devices according to claim 10, characterised in that during the prescribed activity of the one application device, the adjacent application device has its application activity stopped by the advanced liquid deflecting rail and is prepared for a future application activity by rinsing and removing the rinsing liquid by means of the advanced liquid deflecting rail and the associated liquid collecting tray and is supplied in good time and completely with the following liquid for application.
